(19) United States
(12) Patent Application Publication
(10) Pub. No.: US 2007/0087248 A1
(43) Pub. Date: Apr. 19, 2007

(54) Proton conductive electrolyte membrane, method of preparing the same and fuel cell including the proton conductive electrolyte membrane

(75) Inventor: Fusaki Fujibayashi, Yokohama-si (JP)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/581,423

(22) Filed: Oct. 17, 2006

(30) Foreign Application Priority Data
Oct. 18, 2005 (JP) 2005-302727
Mar. 30, 2006 (KR) 2006-29067

(51) Int. Cl. H01M 8/10

(52) U.S. Cl. 429/33; 429/307

(57) ABSTRACT

A proton conductive polymer electrolyte membrane, a method of preparing the same and a fuel cell including the proton conductive polymer electrolyte membrane, and more particularly, a proton conductive electrolyte membrane formed by impregnating polybenzimidazoles with inorganic phosphoric acids and organic phosphonates, wherein a total amount of the inorganic phosphoric acids and organic phosphonates is in the range of 20-2,000 mol % with respect to a repeating structure unit of polybenzimidazoles, and a molar ratio between the inorganic phosphoric acids and the organic phosphonates (inorganic phosphoric acids:organic phosphonates) is in the range of 5:95-90:10, a method of preparing the same and a fuel cell including the proton conductive electrolyte membrane. In addition, there is provided a proton conductive electrolyte membrane having good electricity generating performance in a non-humidified environment or at a relative humidity of 50% or less and at an operating temperature of 100 to 300° C., and also having a good resistance to being dissolved in acid while stably maintaining a good electricity generating performance for a longer period of time by delaying the dissolution of the electrolyte membrane in the acid as compared to the prior art, a method of preparing the same and a fuel cell including the proton conductive electrolyte membrane.

### CROSS-REFERENCE TO RELATED APPLICATIONS

This application claims the benefit of Japanese Patent Application No. 2005-302727, filed on Oct. 18, 2005, in the Japanese Patent Office, and Korean Patent Application No. 2006-29067, filed on 30 Mar. 2006, in the Korean Patent Office, the disclosures of which are incorporated herein by reference.

### BACKGROUND OF THE INVENTION

1. Field of the Invention

An aspect of the present invention relates to a proton conductive electrolyte membrane, a method of preparing the same and a fuel cell including the proton conductive electrolyte membrane, and more particularly, to a proton conductive electrolyte membrane that has a good resistance to being dissolved in acid, and stably generates electricity in a non-humidified environment or at a relative humidity of 50% or less and at an operating temperature of 100 to 300° C. for a long period of time, a method of preparing the same and a fuel cell including the proton conductive electrolyte membrane.

2. Description of the Related Art

Ion conductors, through which ions move when a voltage is applied, are widely used in electrochemical devices, such as batteries, electrochemical sensors, and the like. For example, proton conductors, which have stable proton conductivity in a non-humidified environment or at a relative humidity of 50% or less and at an operating temperature of 100 to 300° C. over a long period of time, are preferably used in fuel cells in terms of power generating efficiency and system efficiency.

Therefore, much research into solid polymer fuel cells has been conducted in consideration of the above-mentioned requirements. However, a solid polymer fuel cell containing a perfluorocarbon sulfonic acid membrane as an electrolyte membrane cannot generate sufficient electricity in a non-humidified environment or at a relative humidity of 50% or less and at an operating temperature of 100 to 300° C.

In addition, a membrane containing a proton conducting agent (disclosed in Japanese Patent Laid-open Publication No. 2001-35509), a silica dispersing membrane (disclosed in Japanese Patent Laid-open Publication No.1994-111827), an inorganic-organic composite membrane (disclosed in Japanese Patent Laid-open Publication No. 2000-090946), a grafted membrane doped with phosphoric acid (disclosed in Japanese Patent Laid-open Publication No. 2001-213987), and a ionic liquid composite membrane (disclosed in Japanese Patent Laid-open Publication Nos. 2001-167629 and 2003-123791) have been developed.

Also, a technique of using a polymer electrolyte membrane composed of polybenzimidazole doped with a strong acid such as phosphoric acid is disclosed in U.S. Pat. No. 5,525,436.

However, all of these inventions are not suitable for stably generating sufficient electricity in a non-humidified environment or at a relative humidity of 50% or less and at an operating temperature of 100 to 300° C. In addition, phosphoric acid fuel cells, solid oxide fuel cells, and molten salt fuel cells operate at a temperature much higher than 300° C. so that they do not satisfy requirements in terms of manufacturing costs.

In addition, an electrolyte membrane in which a polybenzimidazole membrane is doped with an orthophosphoric acid is disclosed in U.S. Patent Publication No. 5,525,436. Polybenzimidazole can become swollen in a high level orthophosphoric acid at room temperature due to its molecular structure, and can have high ion conductivity. However, original polybenzimidazole is a polymer prepared by condensation polymerization using polyphosphate as a polymerization space as disclosed in U.S. Pat. No. 3,313,783, U.S. Pat. No. 3,509,108, and U.S. Pat. No. 3,555,389. Therefore, the polybenzimidazole is partially dissolved in orthophosphoric acid, and particularly the tendency to dissolve is significantly increased as the temperature increases.

In a polymer electrolyte membrane used in a fuel cell formed of solid polymer, high proton conductivity and high long-term stability are required. A polymer electrolyte membrane in which a polybenzimidazole membrane is doped with orthophosphoric acid exhibits good performance in terms of proton conductivity or initial fuel cell characteristics, but does not have high long-term stability because the polybenzimidazole membrane is slowly dissolved in acid doped at a high temperature.

### SUMMARY OF THE INVENTION

An aspect of the present invention provides a proton conductive electrolyte membrane that generates electricity in a non-humidified environment or at a relative humidity of 50% or less and at an operating temperature of 100 to 300° C., and also has a good resistance to being dissolved in acid, thus stably maintaining the generation of electricity for a longer period of time by delaying dissolution of the electrolyte membrane in acid as compared to the prior art, a method of preparing the same and a fuel cell including the proton conductive electrolyte membrane.

According to an aspect of the present invention, there is provided a proton conductive electrolyte membrane that is formed by impregnating polybenzimidazoles with inorganic phosphoric acids and organic phosphonates, wherein a total amount of the inorganic phosphoric acids and organic phosphonates is in the range of 20-2,000 mol % with respect to a repeating structure unit of polybenzimidazoles, and a mol ratio between the inorganic phosphoric acids and the organic phosphonates (inorganic phosphoric acids: organic phosphonates) is in the range of 5:95-90:10

According to another aspect of the present invention, there is provided a method of preparing a proton conductive electrolyte membrane, the method including impregnating polybenzimidazoles with a mixing solution in which the inorganic phosphoric acids and the organic phosphonates are mixed with a mol ratio (inorganic phosphoric acids: organic phosphonates) of 5:95-90:10.

According to still another aspect of the present invention, there is provided a fuel cell having a unit cell structure including an oxygen electrode, a fuel electrode, an electrolyte membrane interposed between the oxygen electrode and the fuel electrode, a oxidizing agent bipolar plate having oxidizing agent flow paths disposed on the oxygen electrode, and a fuel bipolar plate having fuel flow paths disposed on the fuel electrode, wherein the electrolyte membrane is the above proton conductive electrolyte membrane.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional diagram illustrating a unit cell structure of a fuel cell according to an embodiment of the present invention;

FIG. 2 is a graph showing the relationship between a mol ratio of vinyl phosphonate to ortho phosphoric acid of an electrolyte membrane and mass maintenance ratio, and the relationship between a mol ratio of vinyl phosphonate to ortho phosphoric acid of an electrolyte membrane and ion conductivity;

FIG. 3 is a graph showing the relationship between initial closed circuit voltage of a fuel cell including an electrolyte membrane of Example 6 and Comparative Example 1, respectively and current density of generated electricity; and

FIG. 4 is a graph showing the relationship between closed circuit voltage of a fuel cell of Example 6 and Comparative Example 1, respectively and an operating time, and the relationship between closed circuit voltage thereof under a condition of current density of 0.3 mA/cm² and an operating time.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As a result of conducting many studies to solve the problems of the art, by considering an imidazole backbone part included in polybenzimidazoles, and a phenylene backbone part being more organic than the imidazole backbone part, it is found that an electrolyte membrane having insoluble polybenzimidazole and high proton conductivity can be obtained by doping polybenzimidazole with acid in which inorganic phosphoric acids and organic phosphates are mixed with a predetermined mol ratio.

That is, a proton conductive electrolyte membrane according to an embodiment of the present invention can be formed by impregnating polyimidazoles with inorganic phosphoric acids and organic phosphates. With respect to a repeating structure unit of polybenzimidazoles, a total amount of the inorganic phosphoric acids and organic phosphates is in the range of 20-2,000 mol %, and a mol ratio between the inorganic phosphoric acids and the organic phosphates (inorganic phosphoric acids: organic phosphates) is in the range of 5:95-90:10.

A proton conductive electrolyte membrane (hereinafter, referred to as an electrolyte membrane) according to an embodiment of the present invention is composed of inorganic phosphoric acids and organic phosphoric acids that are impregnated in polybenzimidazoles.

Hereinafter, each component included in an electrolyte membrane according to embodiments of the present invention will be described.

Polybenzimidazoles are basic constituents of an electrolyte membrane according to an embodiment of the present invention, and thus the electrolyte membrane remains in a certain shape due to this. According to an aspect of the present invention, the electrolyte membrane is obtained by impregnating membrane-shaped polybenzimidazoles with inorganic phosphoric acids and organic phosphates.

In addition, polybenzimidazoles have excellent heat-resistance properties and can accept large amounts of inorganic acids or organic phosphates when impregnated into a polybenzimidazole, thus being a desirable constituent of an electrolyte membrane for a fuel cell.

Polybenzimidazoles according to an embodiment of the present invention may be polymers represented by Formulae 1 through 3, or derivatives of these. In particular, the derivatives of these may be methylated polybenzimidazoles substituted with a methyl group.

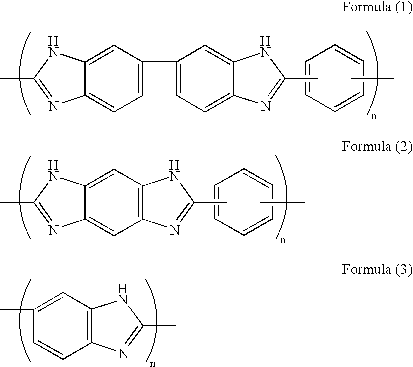

where n refers to the number of a repeating structure unit which ranges from 10-100,000. When n is 10 or more, a mechanical strength of polybenzimidazoles is improved, and thus a solid electrolyte membrane can be obtained. When n is 100,000 or less, polybenzimidazoles are easily soluble in an organic solvent, and thus formability of the polybenzimidazoles is improved, and an electrolyte membrane can be easily shaped.

Polybenzimidazoles can be prepared by known techniques, for example, methods of preparing polybenzimidazoles disclosed in U.S. Pat. No. 3,313,783, U.S. Pat. No. 3,509,108, U.S. Pat. No. 3,555,389 and the like.

Next, inorganic phosphoric acids to be impregnated in polybenzimidazoles may be meta-phosphoric acid, ortho phosphoric acid, para-phosphoric acid, triphosphate, tetraphosphate and the like, and more preferably ortho phosphoric acid.

In addition, organic phosphonate to be impregnated in polybenzimidazoles may be alkylphophonates such as methylphosphonate, ethylphosphonate, propylphosphonate and the like, or vinylphosphonate, phenylphosphonate, and more preferably vinylphosphonate.

An impregnation ratio (doping amount) of the inorganic phosphoric acids and organic phosphates with polybenzimidazoles is preferably in the range of 20-2,000 mol %, and more preferably 50-1,500 mol %, with respect to a repeating structure unit of polybenzimidazoles.

The impregnation ratio can be obtained using Equation 1 below where Wᵢ and W_{d} refer respectively to the mass of an electrolyte membrane before and after acids are impregnated, Mᵤ refers to a molecular weight of a repeating structure unit of polybenzimidazoles, a refers to a mole number of the inorganic phosphoric acids when a total mole number of the inorganic phosphoric acids and the organic phosphates acids is to be 100, and Mᵢₚ and Mₒₚ respectively refer to a molecular weight of inorganic phosphoric acids and organic phosphates.
Impregnation rate (%)=(W_{d}−Wᵢ)Mᵤ/Wᵢ(a Mᵢₚ/100+(1−a/100)Mₒₚ)×100 Equation (1)

When the impregnation rate is 20 mole % or more, proton conductivity of an electrolyte membrane is substantially high, and when the electrolyte membrane is employed in a fuel cell, a good electric generating performance can be obtained. In addition, when the impregnation ratio is 2,000 mole % or less, the impregnation ratio for polybenzimidazoles is within a proper range, polybenzimidazole is insoluble, and thus proton conductivity can be stably maintained for a long period of time.

In addition, a molar ratio of inorganic phosphoric acids and organic phosphates (inorganic phosphoric acids: organic phosphates) is preferably in the range of 5:95-90:10, and more preferably 10:90-85:15. When a molar ratio of inorganic phosphoric acids and organic phosphates is within this range, electrical chemical properties of an electrolyte membrane are not damaged, and dissolution of an electrolyte membrane at a high temperature can be prevented.

When inorganic phosphoric acids or organic phosphates are independently impregnated with polybenzimidazoles, polybenzimidazoles can be easily dissolved.

Polybenzimidazoles have a phenylene backbone part (a six-membered ring consisting of carbon) and an imidazole backbone part (a five-membered ring consisting of carbon and nitrogen). The imidazole part has a hydrogen atom that is bound to a nitrogen atom, and molecular chains of polybenzimidazoles strongly interact with one another by hydrogen binding between molecules occurring between the nitrogen-hydrogen atoms. In addition, the imidazole backbone part is more hydrophilic than the phenylene backbone part. On the other hand, the phenylene backbone part has a higher organicity (hydrophobic property) than the imidazole backbone part.

When inorganic phosphoric acids, such as ortho phosphoric acid which is an example thereof, are impregnated with polybenzimidazoles, inorganic phosphoric acids are likely to interact with the imidazole backbone part having low organicity rather than the phenylene backbone part. In addition, when ortho phosphoric acid reacts with the imidazole backbone part, the imidazole part is solvated by the inorganic phosphoric acids. Accordingly, interaction between molecular chains of polybenzimidazoles is broken, and thus the polybenzimidazoles are dissolved. An electrolyte membrane obtained by impregnating polybenzimidazoles with only inorganic phosphoric acids has a good proton conductivity. Therefore, it is desirable to use the electrolyte membrane as an electrolyte membrane for a fuel cell. However, the electrolyte membrane is likely to be dissolved at a high temperature of 100° C. or more as described above.

In addition, when polybenzimidazoles are impregnated with organic phosphonates, the organic phosphonates are likely to interact with a phenylene backbone part. When ortho phosphoric acid reacts with the phenylene backbone part, the phenylene part is solvated by organic phosphonates. Accordingly, interaction between molecule chains of polybenzimidazoles is broken, and thus the polybenzimidazoles are dissolved.

Meanwhile, in the electrolyte membrane according to the current embodiment of the present invention, dissolution of polybenzimidazoles can be prevented by impregnating polybenzimidazoles with inorganic phosphoric acids and organic phosphonates. By mixing inorganic phosphoric acids and organic phosphoric acids in a certain mol ratio, the organic phosphonates inhibit the inorganic phosphonates from being coordinated with the imidazole backbone part, in contrast, the inorganic phosphoric acids inhibit the organic phosphonates from being coordinated with the phenylene backbone part. As a result, the forming of solutions of inorganic phosphoric acids and organic phosphonates with respect to polybenzimidazoles is properly inhibited, and solubility of polybenzimidazoles in acid is reduced.

Therefore, since the electrolyte membrane according to the current embodiment of the present invention comprises polybenzimidazoles impregnated with inorganic phosphoric acids and organic phosphonates, the electrolyte membrane can exhibit high proton conductivity, prevent polybenzimidazoles from being dissolved in acid, and stably maintain proton conductivity at a high temperature for a long period of time.

The electrolyte membrane according to the current embodiment of the present invention can be easily prepared by immersing polybenzimidazoles in a mixing solution including inorganic phosphoric acids and organic phosphonates that are mixed together in a molar ratio (inorganic phosphoric acids:organic phosphonates) of 5:95-90:10 and then impregnating polybenzimidazoles with inorganic phosphoric acids and organic phosphonates.

More particularly, for example, a solution in which polybenzimidazoles are dissolved is coated on glass, etc., and heated to obtain a membrane-shaped polybenzimidazole film. Next, the polybenzimidazole film is immersed in a solution including inorganic phosphoric acids and organic phosphonates that are mixed together with a molar ratio as described above, and then the polybenzimidazole film is impregnated with inorganic phosphoric acids and organic phosphonates. An impregnation rate can be controlled by adjusting, for example, impregnation temperature and time of impregnation.

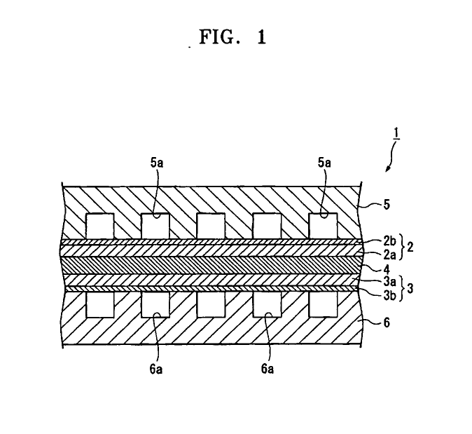

FIG. 1 is a cross-sectional diagram illustrating a unit cell structure of a fuel cell according to an embodiment of the present invention. Referring to FIG. 1, the unit cell 1 includes an oxygen electrode 2, a fuel electrode 3, an electrolyte membrane 4 according to the current embodiment of the present invention interposed between the oxygen electrode 2 and the fuel electrode 3, an oxidizing agent bipolar plate 5 having oxidizing agent flow paths 5a disposed on the external surface of the oxygen electrode 2, and a fuel bipolar plate 6 having fuel flow paths 6a disposed on the external surface of the fuel electrode 3. The unit cell 1 operates at 100-300° C., and in a non-humidified environment or a relative humidity of 50% or less.

The fuel electrode 3 and the oxygen electrode 2 respectively include porous catalyzing layers 2a and 3a, and porous carbon sheets 2b and 3b that respectively support each of the porous catalyzing layers 2a and 3a. The porous catalyzing layers 2a and 3a include an electrode catalyst, a hydrophobic binder for solidifying and shaping the electrode catalyst, and a conducting agent.

The catalyst can be any metal that catalyzes oxidation reaction of hydrogen and reduction reaction of oxygen. Examples of the catalyst include lead (Pb), iron (Fe), manganese (Mn), cobalt (Co), chrome (Cr), gallium (Ga), vanadium (V), tungsten (W), ruthenium (Ru), iridium (Ir), palladium (Pd), platinum (Pt), rhodium (Rh) or alloys thereof, but are not particularly limited. These metals or alloys are supported in activated carbon to comprise the electrode catalyst.

In addition, the hydrophobic binder may be, for example, a fluorine resin, and preferably a fluorine resin having a melting point of 400° C. or less. Such a fluorine resin can be a resin having good hydrophobic properties and heat resistance such as polytetrafluoroethylene, tetrafluoroethylene-perfluoroalkylvinylether copolymer, polyvinylidene fluoride, tetrafluoroethylene-hexafluoroethylene copolymer, perfluoroethylene, etc. By adding the hydrophobic binder, the catalyzing layers 2a and 3a can be prevented from becoming excessively wet due to water generated by an electricity generating reaction, and diffusion inhibition of fuel gases and oxygen inside of the fuel electrode 3 and the oxygen electrode 2 can be prevented.

In addition, the conducting agent can be any electricity-conducting material, for example, any kind of metal or carbon material. Examples of the conducting agent include carbon black such as acetylene black, etc., activated carbon and graphite, and these can be used independently or in combination.

In addition, the catalyzing layers 2a and 3a can comprise constituents of the electrolyte membrane according to the current embodiment of the present invention instead of the hydrophobic binder, or together with the hydrophobic binder. By adding constituents of the electrolyte membrane according to the current embodiment of the present invention, proton conductivity in the fuel electrode 3 and the oxygen electrode 2 can be improved, and internal resistance of the fuel electrode 3 and the oxygen electrode 2 can be reduced.

The oxidizing agent bipolar plate 5 and the fuel bipolar plate 6 are composed of a conductive metal, etc., and are joined to the oxygen electrode 2 and the fuel electrode 3 to act as a current collector and supply oxygen and fuel gases to the oxygen electrode 2 and fuel electrode 3, respectively. That is, hydrogen as a fuel gas is supplied to the fuel electrode 3 via the fuel flow paths 6a of the fuel bipolar plate 6 and oxygen as an oxidizing agent is supplied to the oxygen electrode 2 via the oxidizing agent flow paths 5a of the oxidizing agent bipolar plate 5. The hydrogen supplied as a fuel may be hydrogen produced by modification of hydrocarbon or alcohol and the oxygen supplied as an oxidizing agent may be oxygen in air.

In the unit cell 1, hydrogen is oxidized at the fuel electrode 3 to produce protons which migrate to the oxygen electrode 2 via the electrolyte membrane 4. The migrated protons electrochemically react with oxygen to produce water, thereby producing electrical energy.

A fuel cell operates at 100-300° C., and dissolution of polybenzimidazoles of an electrolyte membrane increases in such a temperature range. Since the electrolyte membrane according to the current embodiment of the present invention includes polybenzimidazoles impregnated with inorganic phosphoric acids and organic phosphonates, the electrolyte membrane can exhibit high proton conductivity, prevent polybenzimidazoles from being dissolved in acid, and stably maintain proton conductivity at a high temperature for a long period of time.

Due to the compositions, a fuel cell having a good electricity generating performance in a non-humidified environment or at a relative humidity of 50% or less and at an operating temperature of 100 to 300° C. for a long period of time, can be properly used for cars, for power generation at home or for portable applications.

Hereinafter, an aspect of the present invention will be described in greater detail with reference to the following examples.

### EXAMPLES 1 THROUGH 8 and COMPARATIVE EXAMPLES 1 THROUGH 5

First, a polybenzimidazole membrane was prepared using the following process.

With reference to a method of preparing a polybenzimidazole membrane disclosed in U.S. Patent Publication No. 3,313,783, U.S. Patent Publication No. 3,509,108, and U.S. Patent Publication No. 3,555,389, poly-2,2′-(m-phenylene)-5,5′-bibenzimidazole (PBI) was prepared. Next, 1 g of the PBI was dissolved in 10 g of dimethylaceteamide (DMAC), in an oil bath, and the dissolved liquid was cast on glass on a hot plate. Then, DMAC was removed until a film was obtained. In addition, the resulting product was vacuum dried at 120° C. for 12 hours and then DMAC was completely removed to prepare a PBI membrane having a thickness of 20 μm.

Next, ortho phosphoric acid (manufactured by Tokyo Chemical Industry) with a purity of 85% as an inorganic phosphoric acid, and vinylphosphonate (manufactured by Tokyo Chemical Industry) with a purity of 85% as an organic phosphonate were prepared, and a mixing solution was prepared by mixing ortho phosphoric acid and vinylphosphonate in a predetermined molar ratio. The prepared PBI membrane was immersed in the mixing solution at a room temperature for two hours, and then the PBI membrane were impregnated with phosphoric acid and vinylphosphonate.

Like this, electrolyte membranes of Examples 1 through 8 and Comparative Examples 1 through 5 were prepared. A mixing ratio of ortho phosphoric acid to vinylphosphonate in each electrolyte membrane is shown in Table 1.

In addition, a total amount of ortho phosphoric acid and vinylphosphonate with respect to a repeating structure unit of PBI in each Example and each Comparative Example was calculated using Equation 1. The results are shown in Table 1.

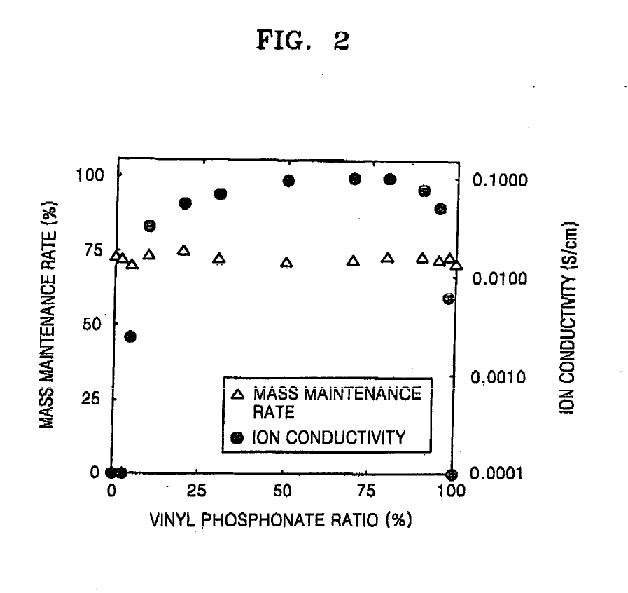

With respect to the obtained electrolyte membranes, mass maintenance ratio and proton conductivity at 150° C. were measured by the following processes. The results are shown in Table 1 and FIG. 2.

Mass Maintenance Rate

A PBI membrane without doping treatment was prepared, and the PBI membrane was immersed in a mixing solution in which ortho phosphoric acid and vinylphosphonate were mixed with mixing ratios (mol ratios) shown in Table 1, respectively, and placed in an oven of 150° C. for one hour. Then, the PBI membrane was taken out of the mixing solution, washed and dried, and then a mass maintenance rate was measured from a difference of mass of before and after immersion. The mass maintenance rate refers to solubility of a PBI membrane with respect to a mixing solution. As the mass maintenance rate increases, solubility of the PBI membrane with respect to the mixing solution decreases. Such a mass maintenance rate is measured in the condition that a greater amount of phosphoric acid is contained in the mixing solution, with respect to electrolyte membranes of the Examples and the Comparative Examples and corresponds to an accelerated test for evaluating acid solubility of the Examples and the Comparative Examples.

Proton Conductivity

Electrolyte membranes of Examples 1 through 8 and Comparative Examples 1 through 5 were placed between platinum electrodes (diameter 13 mm), proton conductivity was obtained from resistance values obtained by complex impedence measurement at 150° C.

TABLE 1

| | Comparative | Comparative | Comparative | | | | |
|---|---|---|---|---|---|---|---|
| | Example 1 | Example 2 | Example 3 | Example 1 | Example 2 | Example 3 | Example 4 |
| Molar Ratio Of | 0 | 2 | 5 | 10 | 20 | 30 | 50 |
| Vinylphosphonate (Mol %) | | | | | | | |
| Impregnation | 1100 | 1120 | 1130 | 1120 | 1100 | 1090 | 1080 |
| Rate (Mol %) | | | | | | | |
| Mass Maintenance | 0 | 0 | 45.9 | 83.0 | 91.0 | 94.2 | 98.8 |
| Rate (Mol %) | | | | | | | |
| Proton | 0.016 | 0.015 | 0.013 | 0.016 | 0.018 | 0.015 | 0.014 |
| Conductivity (S/cn) | | | | | | | |

| | | | | | Comparative | Comparative |
|---|---|---|---|---|---|---|
| | Example 5 | Example 6 | Example 7 | Example 7 | Example 4 | Example 5 |
| Molar Ratio Of | 70 | 80 | 90 | 95 | 98 | 100 |
| Vinylphosphonate (Mol %) | | | | | | |
| Impregnation | 1060 | 1100 | 1050 | 1020 | 990 | 1000 |
| Rate (Mol %) | | | | | | |
| Mass Maintenance | 99.8 | 99.8 | 95.9 | 90.0 | 59.8 | 0 |
| Rate (Mol %) | | | | | | |
| Proton | 0.015 | 0.016 | 0.016 | 0.015 | 0.016 | 0.014 |
| Conductivity (S/cn) | | | | | | |

As can be seen in Table 1, when a molar ratio of vinylphosphonate is within 10-95%, a mass maintenance ratio represents good resistance to being dissolved in acid of 80% or more, and an electrolyte membrane has good proton conductivity of 0.01 S/cm or more.

Meanwhile, when a molar ratio of vinylphosphonate is less than 0-10% and greater than 95%, proton conductivities of the Comparative Examples are slightly different to proton conductivities of the Examples. However, in measurement of a mass maintenance rate in an accelerated test, a PBI membrane is partially or completely dissolved, thereby having a lower resistance to being dissolved in acid.

Next, a commercially available electrode for a fuel cell (manufactured by Electrochem Co.) was set to a pair of porous electrodes, and a unit fuel cell was prepared by inserting electrolyte membranes of Example 6 and Comparative Example 1.

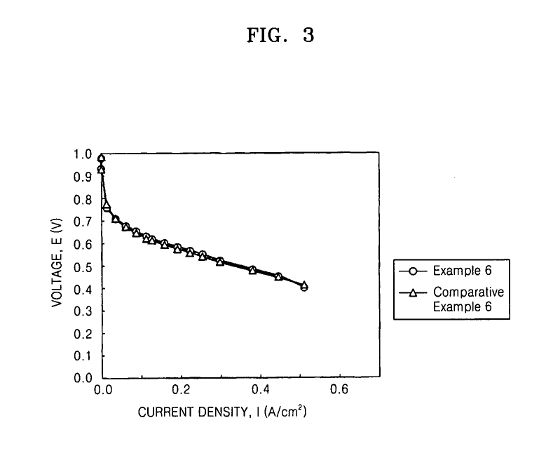

A fuel and an oxidizing agent were provided with hydrogen and air, respectively, and a power generation experiment was performed at 150° C. Power generation efficiency of the initial power generation is shown in FIG. 3.

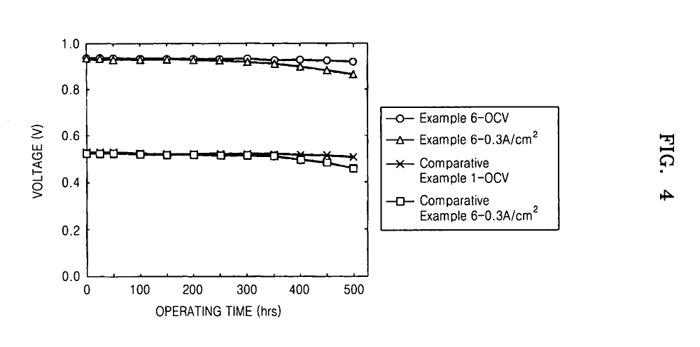

In addition, power generation was performed to obtain constant current corresponding to a current density of 300 mA/cm², the fuel cell was operated for a long period of time, and a consecutive change of closed circuit voltage was measured. Also, a consecutive change of open circuit voltage (OCV) was simultaneously measured. The results are shown in FIG. 4.

As shown in FIG. 3, there was no initial power generation efficiency difference between Example 6 and Comparative Example 1. However, as shown in FIG. 4, in a power generation experiment for a long period of time, while Example 6 had no degradation of open circuit voltage and closed circuit voltage at about 500 hours, closed circuit voltage and open circuit voltage were slowly reduced at around 300 hours in Comparative Example 1. This was because PBI compositions included in an electrolyte membrane were slowly dissolved.

As noted above, it is seen that electrolyte membranes of Examples 1 through 8 have good electrical characteristics and resistance to being dissolved in acid compared to electrolyte membranes of Comparative Examples 1 through 5.

### EXAMPLE 9

Methylphophonate (manufactured by Aldrich Co.) as an organic phosphonate was prepared. A mixing solution in which a molar ratio of orthophosphate and methylphosphonate (orthophosphate:methylphosphonate) is 80:20 was prepared. An electrolyte membrane was prepared in the same manner as in Examples 1 through 8 and Comparative Examples 1 through 5 except that a PBI membrane was immersed in the mixing solution. Impregnation rate of Example 9 was 1050 mol %.

A mass maintenance rate and proton conductivity at 150° C. with respect to an electrolyte membrane of Example 9 were measured. The mass maintenance rate was 90.3%, and proton conductivity was 0.016 S/cm. The electrolyte membrane of example 9 exhibited the same performance as that of the electrolyte membranes of Examples 1 through 8.

### EXAMPLES 10 THROUGH 11 and COMPARATIVE EXAMPLES 6 through 7

A mixing solution of orthophosphate and vinylphosphonate was prepared. A molar ratio of vinylphosphonate in the mixing solution was 80 mol %, the same as in Example 6. Electrolyte membranes of Examples 10 and 11 and Comparative Examples 6 and 7 were prepared in the same manner as in Example 6, except that a PBI membrane in Example 10 was immersed in the mixing solution at a room temperature for 10 minutes, a PBI membrane in Example 11 was immersed in the mixing solution at 80° C. for 30 minutes, a PBI membrane in Comparative Example 6 was immersed in the mixing solution at a room temperature for 5 minutes, and a PBI membrane in Comparative Example 7 was immersed in the mixing solution at 80° C. for 90 minutes. Impregnation rate of obtained electrolyte membranes is shown in Table 2. In addition, a mass maintenance rate and proton conductivity at 150° C. of each electrolyte membrane are shown in Table 2.

TABLE 2

| | | | Comparative | Comparative |
|---|---|---|---|---|
| | Example 10 | Example 11 | Example 6 | Example 7 |
| Impregnation | 50 | 1200 | 10 | 2300 |
| rate (mol %) | | | | |
| Proton | 0.010 | 0.019 | 0.007 | unable to |
| conductivity | | | | measure |

As shown in Table 2, when the impregnation rate is in the range of 20-2,000 mol % (Examples 10 and 11), a mass maintenance rate represents good resistance to being dissolved in acid of 80% or more, and also the electrolyte membrane exhibits good proton conductivity of 0.01 S/cm or more.

Meanwhile, when the impregnation rate is less than 20 mol % (Comparative Example 6), the resistance of being dissolved in acid is excellent, but proton conductivity is significantly reduced. In addition, when the impregnation rate is greater than 2,000 mol % (Comparative Example 7), in measurement a mass maintenance rate as an accelerated test, a PBI membrane is partially or completely dissolved, thereby lowering the resistance to being dissolved in acid. Also, in measurement proton conductivity, an electrolyte membrane was placed between platinum electrodes, and thus excessive acid flowed out of the membrane to make measurement of proton conductivity difficult.

A proton conductive electrolyte membrane according to an embodiment of the present invention can operate in a non-humidified condition at a high temperature, exhibit excellent proton conductivity, and excellent properties in terms of durability. By taking advantage of these properties, the proton conductive electrolyte membrane according to an embodiment of the present invention can be widely used in all kinds of fuel electrolyte membrane, sensors, condensers, electrolyte membranes, etc.

The proton conductivity electrolyte membrane according to the present invention comprises polybenzimidazoles impregnated with inorganic phosphoric acids and organic phosphonates in a certain mol ratio and impregnation rate, and thus the electrolyte membrane can exhibit high proton conductivity, prevent polybenzimidazoles from being dissolved in acid, and stably maintain proton conductivity at a high temperature for a long period of time.

In addition, in a method of preparing the proton conductive electrolyte membrane according to an embodiment of the present invention, the proton conductive electrolyte membrane having good resistance to being dissolved in acid can be easily prepared by immersing polybenzimidazoles with a mixing solution composed of inorganic phosphoric acids and organic phosphonates in a certain mol ratio.

In addition, a fuel cell according to an embodiment of the present invention has good solubility in acid, and also includes an electrolyte membrane having good proton conductivity, and thus the fuel cell can stably maintain electricity generating performance in a non-humidified environment or at a relative humidity of 50% or less and at an operating temperature of 100 to 300° C. for a long period of time.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A proton conductive electrolyte membrane formed by impregnating polybenzimidazoles with inorganic phosphoric acids and organic phosphonates, wherein an impregnation ratio of the inorganic phosphoric acids and organic phosphonates is in the range of 20-2,000 mol % with respect to a repeating structure unit of polybenzimidazoles, and a molar ratio between the inorganic phosphoric acids and the organic phosphonates is in the range of 5:95-90:10.

2. The proton conductive electrolyte membrane according to claim 1, wherein the polybenzimidazoles are polymers represented by Formulas 1 through 3 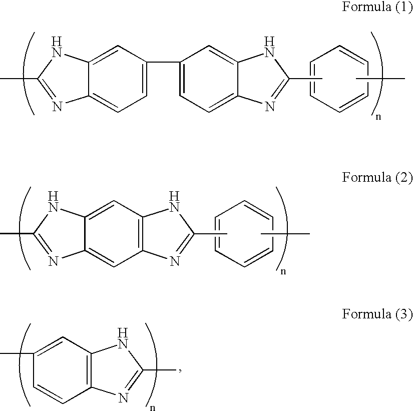
where n refers to the number of the repeating structure units of polybenzimidazoles which ranges from 10-100,000.

3. The proton conductive electrolyte membrane according to claim 1, wherein the inorganic phosphoric acids are selected from the group consisting of meta-phosphoric acid, ortho phosphoric acid, para-phosphoric acid, triphosphate and tetraphosphate.

4. The proton conductive electrolyte membrane according to claim 1, wherein the organic phosphonate is selected from the group consisting of alkylphophonates, vinylphosphonate and phenylphosphonate.

5. The proton conductive electrolyte membrane according to claim 1, wherein the impregnation ratio of the inorganic phosphoric acids and organic phosphonates with polybenzimidazoles is in the range of 50-1,500 mol % with respect to the repeating structure unit of the polybenzimidazoles.

6. The proton conductive electrolyte membrane according to claim 1, wherein the impregnation ratio is obtained by the following equation:
Impregnation rate (%)=(W_{d}−Wᵢ)Mᵤ/Wi(a Mᵢₚ/100+(1−a/100)Mₒₚ)×100,
where Wᵢ and W_{d} refer respectively to the mass of the electrolyte membrane before and after the inorganic phosphoric acids are impregnated, Mᵤ refers to a molecular weight of the repeating structure unit of polybenzimidazoles, a refers to a mole number of the inorganic phosphoric acids when a total mole number of the inorganic phosphoric acids and the organic phosphates acids is to be 100, and Mᵢₚ and Mₒₚ respectively refer to a molecular weight of the inorganic phosphoric acids and the organic phosphates.

7. The proton conductive electrolyte membrane according to claim 1, wherein the molar ratio between the inorganic phosphoric acids and the organic phosphonates is in the range of 10:90-85:15.

8. The proton conductive electrolyte membrane according to claim 1, wherein the polybenzimidazoles include a phenylene backbone part and an imidazole backbone part.

9. The proton conductive electrolyte membrane according to claim 8, wherein the imidazole backbone part includes a hydrogen atom bound to a nitrogen atom, and molecular chains of polybenzimidazoles interact with one another by hydrogen binding.

10. The proton conductive electrolyte membrane according to claim 8, wherein the imidazole backbone part is more hydrophilic than the phenylene backbone part.

11. A method of preparing a proton conductive electrolyte membrane, the method comprising impregnating polybenzimidazoles with inorganic phosphoric acids and organic phosphonates using a mixing solution in which the inorganic phosphoric acids and the organic phosphonates are mixed in a molar ratio of 5:95-90:10.

12. A fuel cell having a unit cell structure comprising an oxygen electrode, a fuel electrode, an electrolyte membrane interposed between the oxygen electrode and the fuel electrode, a oxidizing agent bipolar plate having oxidizing agent flow paths disposed on the oxygen electrode, and a fuel bipolar plate having fuel flow paths disposed on the fuel electrode, wherein the electrolyte membrane is the proton conductive electrolyte membrane of claim 1.

13. A proton conductive electrolyte membrane formed comprising:
inorganic phosphoric acids;
organic phosphonates, and polybenzimidazoles,
wherein the polybenzimidazoles are impregnated with the inorganic phosphoric acids and the organic phosphonates with a molar ratio between the inorganic phosphoric acids and the organic phosphonates in the range of 5:95-90:10.
